(19) United States
(12) Patent Application Publication
(10) Pub. No.: US 2006/0028951 A1
(43) Pub. Date: Feb. 9, 2006

(54) Method of customizing audio tracks

(76) Inventors: Ned Tozun, Palo Alto, CA (US); Ron Eyal, New York, NY (US)

Correspondence Address: Harris Zimmerman;Law Offices of Harris Zimmerman, Suite 710, 1330 Broadway, Oakland, CA, 94612, US

(21) Appl. No.: 11/195,530

(22) Filed: Aug. 1, 2005

Related U.S. Application Data
(60) Provisional application No. 60/598,662, filed on Aug. 3, 2004.

(51) Int. Cl. G11B 3/64

(52) U.S. Cl. 369/84

(57) ABSTRACT

A method for creating a customized audio track involves the steps of creating a song template, and then defining insert regions where sounds, vocals, or the like are inserted into the template. The invention includes the steps of generating a list of inserts, and pre-recording or otherwise acquiring a recording of each insert. When a particular insert is selected, it is introduced into the insert region, and the customized audio track may be recorded, streamed, or otherwise used or delivered to a listener. The audio track may comprise a personalized song (using appropriate name inserts) or a cell phone ring tone that identifies the caller.

### CROSS-REFERENCE TO RELATED APPLICATIONS

This patent application claims the benefit of the filing date of U.S. Provisional Application No. 60/598,662, filed Aug. 3, 2004.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to a system for creating customized audio recordings or audio tracks, typically to correspond with a particular event, situation, condition, or the like. The customization may be carried out with spoken or sung words in a recording, or may be with background or accompany sounds or music. The customized audio track may be recorded, streamed, or otherwise delivered to a listener or receiver.

2. Description of Related Art

Customized audio recordings or audio tracks are well-known in the prior art, although many consumers may not recognize them or consider their origins. One example of a customized audio track is a customized message, such as an audio clock announcement, such as “The time is now eight thirty AM. The time, “eight thirty AM” is the customized portion, and the audio track may be created anew every time the clock is queried or actuated. Note that no recording of the output is actually made in this instance. Another example of a customized audio track is a customized ring tone for a cellular phone that plays a melody and then, e.g., ends with a bird call. The bird call may be the customized portion, and each different call corresponds with the identity of a particular caller.

A personalized audio recording or audio track is one type of customized audio track in which the customization process involves adding a person's name or other personal information, such as gender or age. One well-known example of a personalized audio recording is a typical voice mail greeting that may state the name of the greeter, as well as the telephone number and instructions for leaving a message for the greeter. Note that these messages may be either completely or partially machine-generated, or entirely a recording by the greeter in the individual's own voice. Other examples include personalized music that includes a person's name or other personal references, or personalized ring tones for cellular phones that include the name or personal reference of the caller.

### BRIEF SUMMARY OF THE INVENTION

This invention is directed primarily to a method for creating a customized audio track. The customized audio track may comprise a personalized song in which the customization occurs in the vocals or lyrics. This type of customization contains both background music and vocals, and involves precision in timing of the vocal insertions in synchrony with the music portion of the track. However, the invention is not limited to this aspect, and includes the process as applied to any audio track that contains only vocals, or only music, or any combination of vocal portions with music portions. It may also be applied to the production of video clips, in which at least one video insert is placed into a video template at a video insert region.

The invention involves the steps of creating a song template, and then defining insert regions where sounds, vocals, or the like are inserted into the template. The invention includes the steps of generating a list of inserts, and pre-recording or otherwise acquiring a recording of each insert. When a particular insert is selected, it is introduced into the insert region, and the customized audio track may be recorded, streamed, or otherwise used or delivered to a listener.

In a simple example, the song may comprise a birthday greeting, and the insert list may include a plurality of names, from which the name recipient of the birthday greeting may be selected. Other inserts may relate to the same name choice, or to other topics. The song is customized and personalized by incorporating the name of the recipient into the song itself to form a specialized message.

As a further example, the insert regions may correspond to name of the recipient, the sender's relationship, the type of present accompanying the greeting, and the like. Each insert region has a list of inserts and a corresponding recorded insert for each entry. The user may select one entry from each list, and the system will assemble the inserts with the song template to create a personalized message that is extensively customized. Note that some of the insert lists may include vocalized words that rhyme with other insert lists, or may include nouns, pronouns, or possessives appropriate for the context of the lyrics.

In another example of the invention, the song template is provided with an insert region in which the insert routine may be looped to introduce multiple selections from a list into a single insert region. Thus, for example, a plurality of names may be introduced in one portion of a customized song.

The invention may be applied to creating audio tracks having all lyrics, or all music. In the latter case, one particular use for the invention is the creation of custom ring tones for cell phones. A ring tone template may include a music track having an insert region, and a plurality of inserts may comprise a plurality of bird calls, each bird call being associated with one name on a caller ID name list. Whenever a caller's ID is known and associated with the name list, the ring tone is generated and includes the bird call associated with the caller, so that the recipient may be made aware of the caller's ID, even though nearby individuals would not be apprised of the caller's ID.

### BRIEF DESCRIPTION OF THE DRAWING

FIG. 1 is a schematic view of a song known in the prior art.

FIGS. 2-4 are a series of schematic views depicting the basic concept of a song template having insert regions to receive customizing audio inserts.

FIG. 5 is a pictorial flowchart depicting the steps involved in creating a personalized song.

FIG. 6 is a pictorial flowchart for creating a personalized song as in FIG. 5, in which multiple insert regions are provided with a list of pre-recorded inserts selectable for each region of the template.

FIG. 7 is a pictorial flowchart for creating a personalized song as in FIG. 5, in which one insert region includes a looped insertion routine to introduce multiple selected pre-recorded inserts into the same region of the template.

FIGS. 8 and 9 are schematic views depicting the basic concept of a song (ring tone) template having no lyrics and music insert regions to receive customizing audio inserts.

FIG. 10 is a pictorial flowchart for creating a personalized ring tone of FIGS. 8 and 9, using the steps of FIG. 5, in which the ring tone sound list is correlated with a caller ID name list to produce a ring tone indicative of the caller's ID.

### DETAILED DESCRIPTION OF THE INVENTION

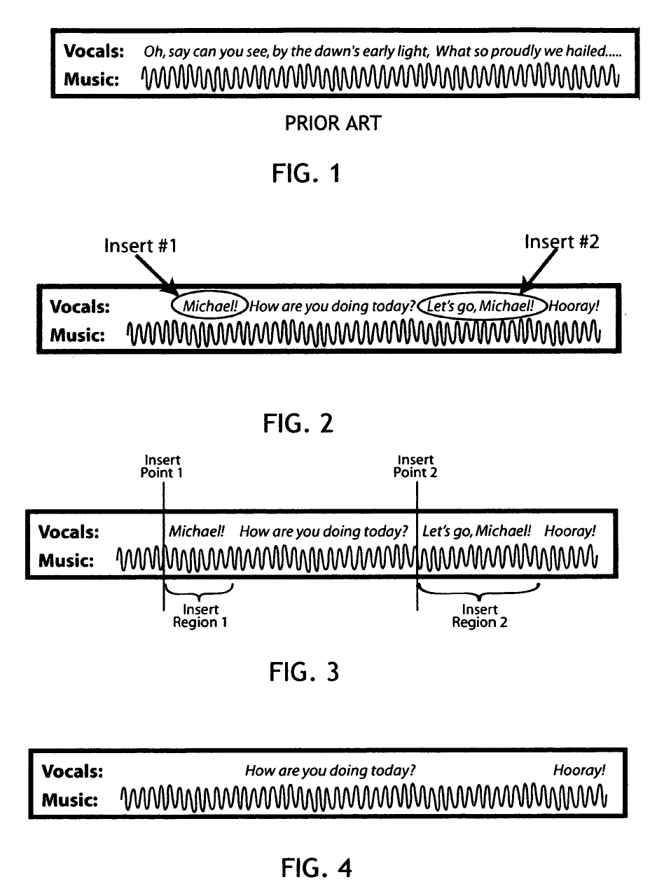

The present invention generally comprises a method for producing a customized song or audio track. With regard to FIG. 1 a typical song known in the art includes a vocal line and a music line. The music line may be intended for background support of the vocal line, but it is feasible for the reverse relationship: the vocal line to be background support for the music line. Both the vocal and music audio may be stored in a mixed state, or in separate tracks of the same digital audio file, or may be generated anew by software when required. The song's vocal and music lines are generally fixed, with no opportunity for customization or personalization. (Improvisational jazz involves customization of at least the music line, but the changes do not necessarily identify the individual musician.)

With reference to FIG. 2, a personalized song may be customized with spoken or sung vocals that contain personal information such as a person's name. These vocal additions are termed vocal inserts. Note that vocal inserts 1 and 2 are spaced apart temporally in the vocal and music lines, and note also that the fixed vocal line may include intervening portions having an rhyming pattern (today/Hooray) that is maintained no matter what words are added as inserts. With reference to FIG. 3, in the personalized song of FIG. 2 each vocal insert begins at an insert point, which is a number that precisely specifies a point in time in the song that corresponds to the start of the respective insert. Typically, the insert point is stored using a sample number referencing a specific time index in the song's digital audio file. For example, an insert point may be defined by the 50,172th sample of the song, or a time code may be used. Typically all the inserts would fit inside a certain range from the insert point; this range is known the insert region. However, an Insert can also be variable in length and can extend outside of this region; the only requirement is that an Insert is inserted at the insert point.

A song may be customized by employing a customization list that specifies the vocal inserts that are placed in the various insert regions. In a personalized song the customization list may be a name list containing all the names for which the song may be customized. With regard to FIG. 4, the song without any personalized inserts in any of the insert regions is termed the template or song template. For example, the “Happy Birthday Abby” song is identical to “Happy Birthday Brad” except where their corresponding names are sung. Moreover, in the typical case, the background music that is behind the vocals in an insert region is identical across all names. Once the song template and the inserts have been created, they may be used to create a mixed personalized song, such as a WAV or MP3 file or any other kind of digital audio file, or to produce personalized audio on the fly, by sending the sound directly to an audio output device such as a speaker or by using streaming audio software.

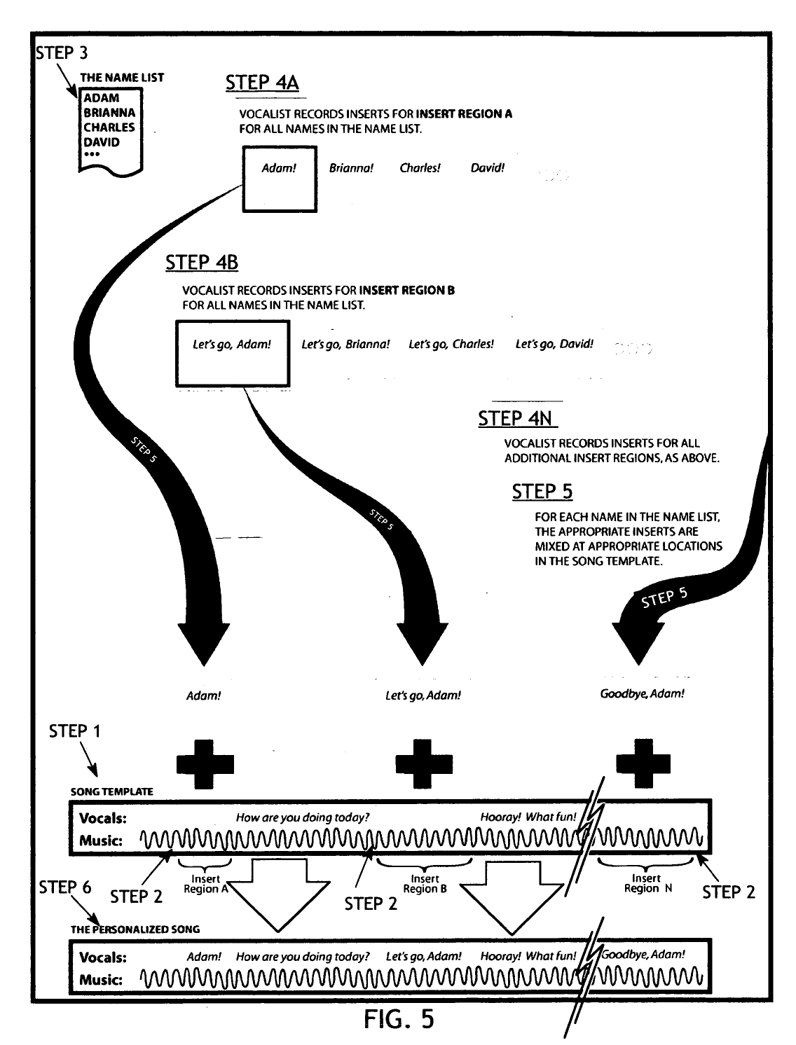

The invention may be carried out by following these steps (see FIG. 5):

1. Create a Song Template of the song.

2. Define all Insert Points in the Song Template. If the Insert is musical, the insert region should be “on the grid”—in other words, the start and end point should both correspond with downbeats in the music to make looping more rhythmic in the playback during the recording phase. Each Insert is given a unique name to identify it.

3. The user inputs a list of names. Optionally, each name can be associated with a sound file in which the name is spoken/pronounced. Typically this name list would be stored in a text file.

4. The recording process is carried out. The vocalist is recorded singing or speaking the inserts as listed in the customization list or name list. Typically, the voice is recorded isolated on its own track without any background effects or music. For spoken inserts that don't have background music cues in the song template, the user can optionally include a click track preceding each insert which cues them when to read their line. The insert is then recorded for each name in the name list, one after the other (steps 4A . . . 4N), onto a single audio track in the recording software. When an insert is successfully recorded and mixed for every name in a Name List, and effects have been applied, it is mixed down to a single file (called the Master Insert File) whose name includes the name of the insert, the length of the loop, and the Name List used to generate the file. The Master Insert File contains the insert recorded for every name in the Name List at evenly spaced intervals, with no background music.

5. Thereafter, a final mixdown may be carried out to create separate digital audio files for each personalized version of the song (step 6). After all the inserts for a song have been recorded, then for every name X in the name list the following steps are taken:

For each name in the name list, the inserts are mixed with the appropriate insert regions in the song template. The resulting mix is saved as a new digital audio file called the Final Mix. The Final Mix is a fully mixed version of the song with name X inserted in the insert regions. Optionally a mastering audio plug-in can be applied to the Final Mix. Batch processing for audio plug-ins is available through software such as Peak.

The final mix may be recorded for later use, or streamed immediately for “real time” use, in which case it may or may not be recorded. If desired, the inserts may also contain music, which could vary with the name. For example, girls names could be accompanied by a flute sound, while boys names could be accompanied by a guitar sound.

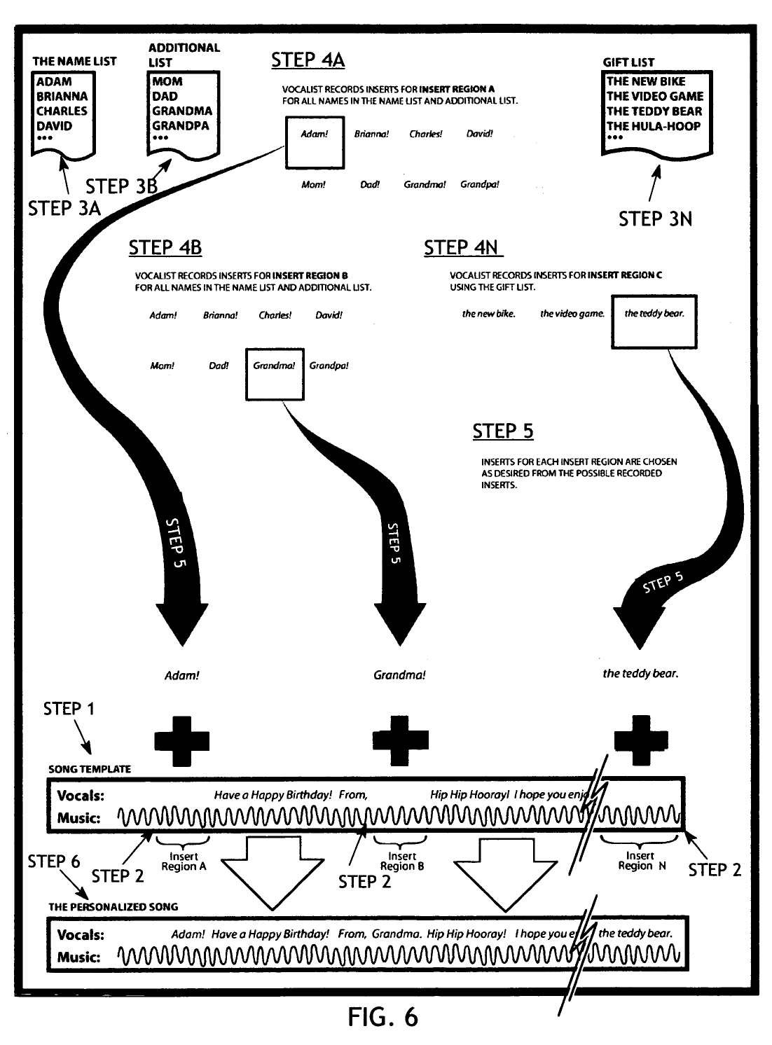

Instead of providing inserts relating to the same name for a personalized version of the song, different names or other words may be combined by providing categorical lists of appropriate words for each insert region. For example, a birthday song for “Adam” could also be personalized with the gift giver (“Grandma”) and what the gift is (“a teddy bear.”). As shown in FIG. 6, the stepwise process of FIG. 5 is modified somewhat to accommodate these inputs. Steps 1 and 2 are substantially the same as described previously, but in step 3 a word or phrase list is created (steps 3A . . . 3N) for each respective insert region A . . . N, each list having a common categorical aspect (name of person, gift giver's relationship, gift items, etc.). In step 4 the vocal recordings are made for each categorical list A . . . N. To make the personalized song of step 6, the user would first choose one entry from each list for each insert region (here, the name of Adam, the relationship being grandmother, the toy being a teddy bear). In step 5 the selected inserts are assembled in the song template to create the personalized song of step 6, which may be recorded or streamed to its point of use or point of sale.

Note that the categories elucidated above are for purposes of example only. Any categories may be used that are appropriate for the message of the song and the circumstances of its creation. Also, some of the category lists may be set to present rhyming words, or may be set to provide the appropriate personal pronoun or possessive (he/his, she/hers, etc.) to maintain proper grammar in the song lyrics.

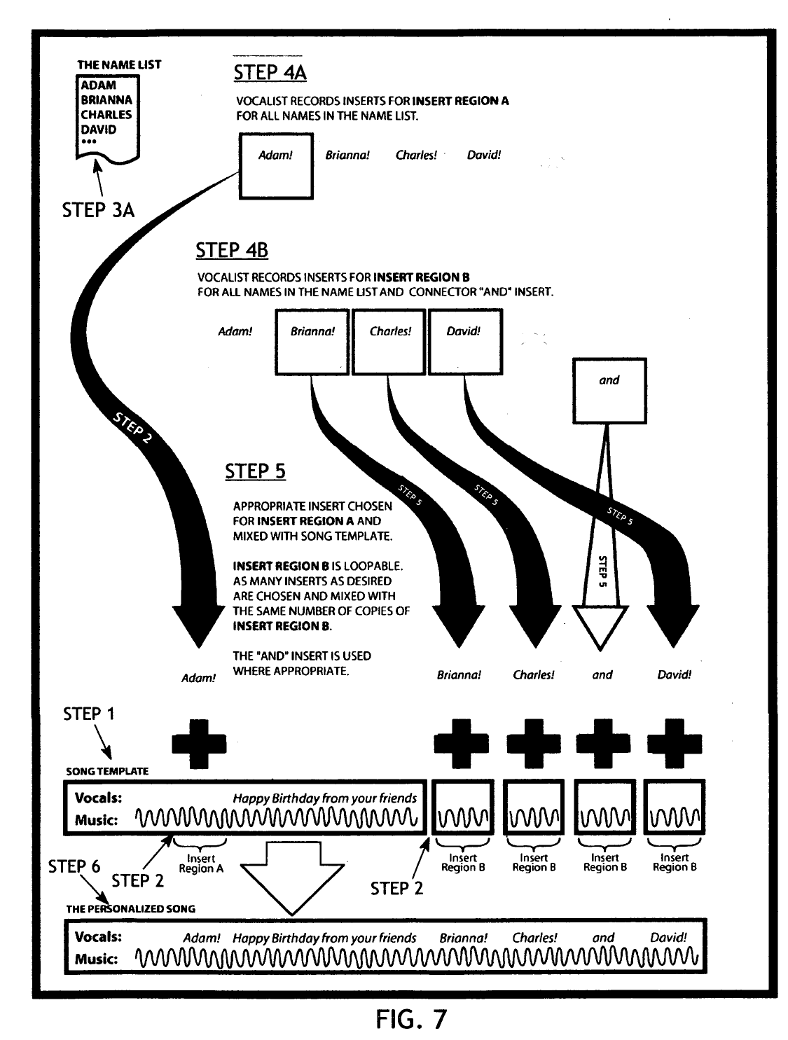

With regard to FIG. 7, the stepwise process of FIGS. 5 and 6 is modified somewhat to provide a song that has a looped insert portion. Steps 1 and 2 are substantially the same as described previously, except that the template is given at least one insert region A to personalize the song, and an insert region B that is adapted to have a looped insertion routine to introduce multiple names from the insert list B into the insert region B. The multiple names in region B are placed serially, with a vocalized “and” conjunction placed between the last and second-to-last insertions in region B. The region B insert recordings may be drawn from the recorded inserts of step 4A, or may be recorded separately in step 4B. In step 5, in which the inserts are placed in the respective regions in the template, the region B insert action loops repeatedly to insert each of the selected names in any ordered manner. The personalized song is then processed and distributed as described previously. Thus, for example, all of the friends who joined in sending the personalized song may have their names included within the song in a very special and personalized message.

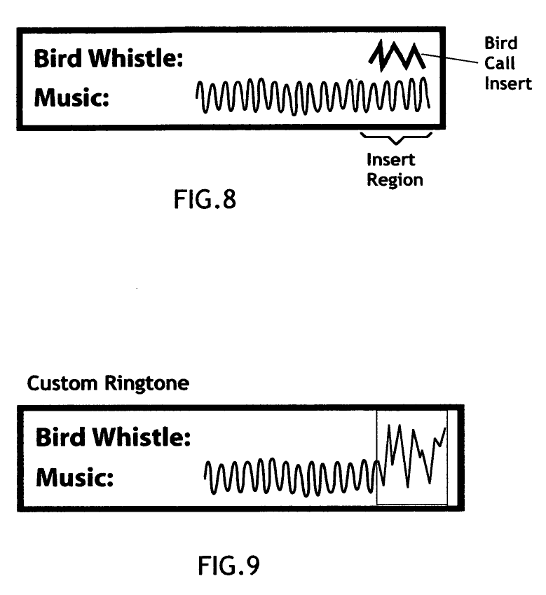

It should be noted that the insertion process of the invention may be applied to a song template that has no music line, only lyrics or spoken words. Alternatively, the insert could contain no vocals and only music. For example, as shown in FIG. 8, a customized song for use as a custom ring tone includes a melody line that ends with a different bird call depending on who is calling. When the ring tone is generated, the cell phone may modify the ring tone by inserting a particular bird call corresponding to the caller's name (FIG. 9). This ring tone system will apprise the user of the identification of the caller, without announcing it overtly to any nearby individuals.

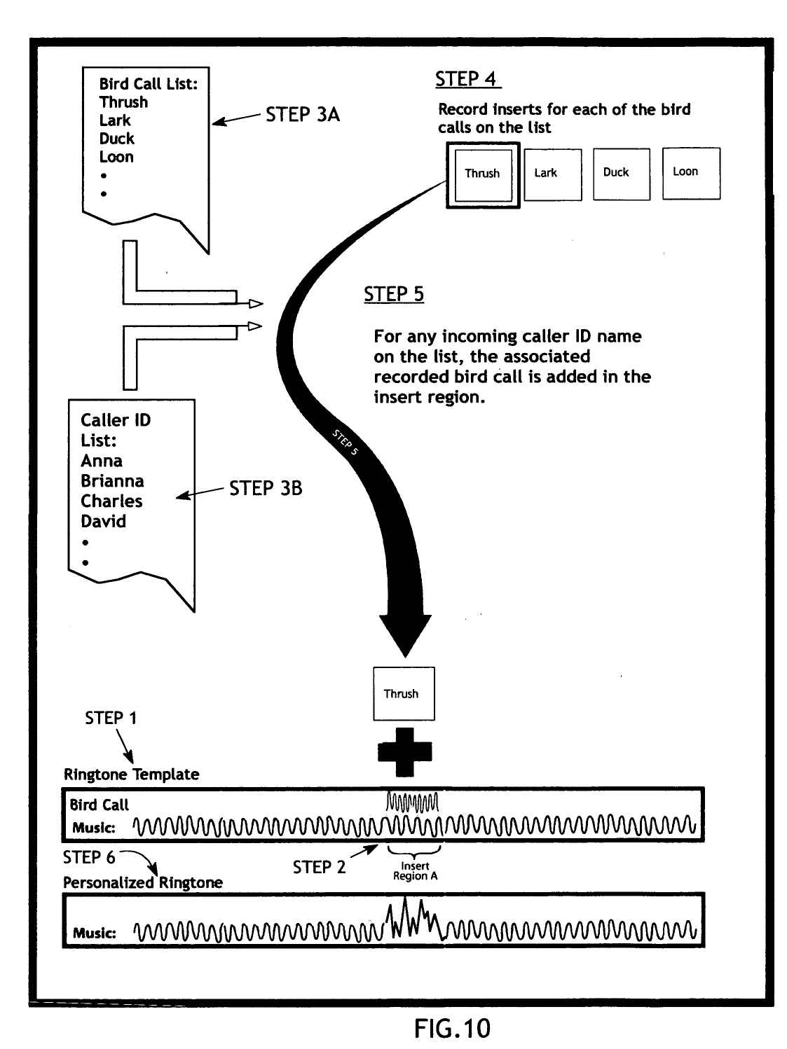

As shown in FIG. 10, the process for generating a customized ring tone is similar to the stepwise process described in the foregoing. Steps 1 and 2 are substantially the same, and in step 3A a list of bird call names is created or acquired, and each is assigned to a name on a caller ID list (step 3B). In step 4, the bird calls are either recorded or obtained from an audio library source, and associated with each name on the list. In step 5 the bird call associated with a particular name on the caller ID list is inserted in the ring tone template whenever that individual is identified as the caller. Note that the bird call may be inserted into an open audio space in the template, or may be added over (mixed with) the existing audio music track. The personalized caller ID ring tone may be recorded for playback as required, or may be generated anew and played aloud whenever the telephone rings and the caller ID matches the caller's name to the ID list. If a final output audio file is generated for this ring tone, both the bird call and background music may be stored mixed together in a single digital file, in separate digital audio files, or in separate tracks of the same digital audio file.

Other sounds, such as animal calls (dog, cat, cow, sheep, lion, monkey, etc.) may be used instead of the bird calls described above. Any of the other features of the invention described above, such as looping the insert routine to add multiple inserts, using multiple insert regions each having an insert sound list, and the like, may be combined with the embodiment of FIG. 10 to generate a wide variety of audio possibilities.

When the recorded inserts are being made, the microphone and recording setup must be adjusted to match the level and sound quality of the original template recording, so that the assembled audio sounds as seamless as possible. The same microphone and vocalist should be used in order to reduce differences in sound quality.

After an insert has been recorded for all names on the name list (or sounds on the sound list), the user may select audio effects to be applied to the recorded inserts. These effects should match the effects applied to the vocals of the sound template, and may include compressor, EQ, and reverb. A software application such as Autotune may be applied to musical inserts to insure accurate tuning.

In addition to being personalized by a singer in a recording studio, the song can also be personalized by the customer with a custom-recorded message using a basic microphone. The customer may simply record the personal portion of the message with a microphone at a retail location, and the recorded message is then is placed in an insert region in the music.

The stepwise process of the invention may be extended to apply to customized video messages. Since digital video content can be stored in much the same way as digital audio content (as a linear time-based representation), the same process described above to create customized audio content can be applied to video to create customized video content. In customized video content, the video may be customized, or the audio may be customized, or both may be customized.

Some examples of Customized Video Content are:

Personalized video ring tone—A video ring tone delivered to a computer or a video-enabled wireless device or cellular phone that combines customized audio of a door knock sound and someone saying “John, are you there?” combined with video of someone knocking on a door. The name spoken in the ring tone is customized to the name of the recipient and the color of the hair of the person knocking on the door may correspond to the color of the hair of the caller. In this case, both the video and audio are customized.

Personalized birthday video message—An animated video delivered to a computer or video-enabled wireless device or cellular phone in which famous cartoon characters dance and sing a birthday song for the recipient. In this case, only the audio is customized, because the synchronization of the audio with the lips of the singers is not critical in an animation, and the screen is small enough that any synchronization problem will not be noticeable.

Customized Video Weather Report—A video delivered to a consumer's TV that contains weather information customized for the consumer based on the locations that the consumer has selected. In this case, both the audio and video would be customized.

All of the process described above for audio have a close analog in the video domain, although the process of mixing a video insert with a video template needs to be refined in order to extend the number of applications. Rather than mixing two video sources in equal proportion, two other forms of video mixing which are potentially more useful are:

Overwriting—In overwriting, the video insert completely replaces the video template in the video insert region.

Blue/Green Screen Masking—The video insert can be shot with a blue or green background and then the background can be removed using blue-screen or green-screen software to create a video with some portions that are transparent. The resulting video insert can then be used as an overlay on the video template, combining elements from both video sources in the insert regions.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. A method for customizing an audio track, including the steps of:
providing an audio track template;
providing at least one insert region in said audio track template;
providing a list of inserts capable of being introduced into said at least one insert region;
providing a recording of each of said inserts on said list;
assembling a customized audio track by selecting at least one of said inserts, and placing the selected recorded insert in the insert region.

2. The method for customizing an audio track of claim 1, wherein said audio track comprises a personalized song, and said list of inserts includes a plurality of names, whereby the name of the intended recipient of the personalized song may be entered into the song.

3. The method for customizing an audio track of claim 2, further including providing a plurality of said insert regions in said template, and each insert region receives an insert that relates to a selected name from the list of inserts.

4. The method for customizing an audio track of claim 1, further including providing a plurality of said insert regions in said template, and providing a separate insert list for each insert region, whereby the insert for each insert region is selected individually from the respective insert list.

5. The method for customizing an audio track of claim 4, wherein one of said insert lists includes a plurality of names, whereby the name of the intended recipient of the customized audio track may be entered in the song.

6. The method for customizing an audio track of claim 5, wherein one of said insert lists includes words describing the relationship of the creator of the customized audio track to the intended recipient of the customized audio track.

7. The method for customizing an audio track of claim 5, wherein one of said insert lists includes words describing a gift accompanying the customized audio track.

8. The method for customizing an audio track of claim 4, wherein at least one of the insert lists contains words that rhyme with the words of at least another of the insert lists.

9. The method for customizing an audio track of claim 4, further including the step of providing at least one of said insert regions with a loopable insert routine, whereby multiple selections from the respective insert list may be introduced into one insert region of the template.

10. The method for customizing an audio track of claim 1, wherein the audio track template includes a melody line and a vocal line, and said inserts are added to said vocal line.

11. The method for customizing an audio track of claim 1, wherein the audio track template includes a music line, and said inserts comprise sounds that are added to said music line.

12. The method for customizing an audio track of claim 11, wherein said sounds are selected from a group including animal calls and bird calls.

13. The method for customizing an audio track of claim 1, further including the step of recording the assembled customized audio track for later use.

14. The method for customizing an audio track of claim 1, further including the step of streaming the assembled customized audio track for immediate use.

15. A method for customizing a telephone ring tone, including the steps of:
providing an ring tone template;
providing at least one insert region in said ring tone template;
providing a list of inserts capable of being introduced into said at least one insert region;
providing a recording of each of said inserts on said list;
assembling a customized ring tone by selecting at least one of said inserts, and placing the selected recorded insert in the insert region.

16. The method for customizing a telephone ring tone of claim 15, further including the step of providing a list of caller ID callers, and associating each of said callers on the list with one of said inserts, whereby the assembled ring tone includes a respective insert that identifies the caller.

17. The method for customizing a telephone ring tone of claim 16, wherein said inserts are selected from a group including animal calls and bird calls.

18. A method for customizing a video track, including the steps of:
providing an video track template;
providing at least one insert region in said video track template;
providing a list of inserts capable of being introduced into said at least one insert region;
providing a recording of each of said inserts on said list;
assembling a customized video track by selecting at least one of said inserts, and placing the selected recorded insert in the insert region.
